(19) United States
(12) Patent Application Publication
(10) Pub. No.: US 2024/0171947 A1
(43) Pub. Date: May 23, 2024

(54) METHOD AND DEVICES FOR MONITORING CONDITIONS THROUGH A STRUCTURE

(71) Applicant: Frank J Bonini, III, Bryn Mawr, PA (US)

(72) Inventor: Frank J Bonini, III, Bryn Mawr, PA (US)

(21) Appl. No.: 18/508,149

(22) Filed: Nov. 13, 2023

Related U.S. Application Data
(63) Continuation-in-part of application No. 18/119,240, filed on Mar. 8, 2023.
Application No. 18/119,240 is a continuation-in-part of application No. 17/581,214, filed on Jan. 21, 2022, now Pat. No. 11,812,782.
(60) Provisional application No. 63/317,686, filed on Mar. 8, 2022.

(51) Int. Cl. H04W 4/38; G01D 21/00

(52) U.S. Cl. CPC H04W 4/38; G01D 21/00

(57) ABSTRACT

A system, method and devices for monitoring several conditions in a containment space or through a surface or panel. A sensor is electronically coupled with a first coil to receive power wirelessly from a compatible second coil of a controller or from a computing device with wireless power transmitting means. The sensor may display the sensor readouts on a display and/or may communicate the information wirelessly to the controller or to another device. The sensor is placed within the containment or on the other side of a surface or panel, and the controller coil/computing device outside of the containment (or other side of the panel), or in some operably spaced apart manner (i.e., within the coil radiance or signal range) from the sensor to provide power to the sensor. The sensor does not require batteries, and the container may remain inaccessible while sensor readings are ascertained and during the monitoring.

### CROSS-REFERENCE TO RELATED APPLICATIONS

This application claims priority and benefit under 35 U.S.C. §§ 119 and 120 to and is a continuation-in-part of U.S. patent application Ser. No. 18/119,240, filed on Mar. 8, 2023, which is a continuation-in-part of U.S. patent application Ser. No. 17/581,214, filed on Jan. 21, 2022, and claims benefit to U.S. Provisional Application Ser. No. 63/317,686, filed on Mar. 8, 2022, the complete contents of which applications are herein incorporated by reference.

### BACKGROUND OF THE INVENTION

### 1. Field of the Invention

The present invention relates to sensors and methods for monitoring a condition, and more particularly, for monitoring an area that may be difficult to access.

### 2. Brief Description of the Related Art

Often conditions are monitored by intrusive means, as many areas or locations may be difficult to access or require destruction or reconstruction of a structure to access the desired area. Also, in some instances, once access is made to an environment, then the integrity of the environments may take place, including, for example, contamination by air, gasses, liquids, light, sound, loss of heat or cooling, or other change. Upon access to some environments, the isolation of the environment may become compromised and no longer suitable. In addition, access may require extensive costs for reconstruction or repair once any protective barrier to the environment or structure has been breached, and, in addition, may take time in order to provide the access needed. Some applications may allow access to an environment, but undertaking that access may cause an adverse condition or effect to the environment, such as releasing or admitting heat or cold air to the environment, breaking a seal that allows contaminants to enter the environment, or other. Also, an environment may be accessible, but a location from which to monitor the environment may require disruption of a sealed structure, or limited access.

A need exists to provide a system, methods and devices for conducting monitoring where access to the structure or sealed environment is not required in order to carry out monitoring, even where a monitoring device, such as a sensor, requires power to operate.

### SUMMARY OF THE INVENTION

A system, method and device for ascertaining conditions of an environment is provided. The system and devices monitor a condition. The system and devices also are configured to communicate information about the conditions being monitored. The communications may be local or through a network, and may be directly to a device nearby or remote from the sensed location.

According to some alternate embodiments, the devices and system may be associated with or include regulating components that respond to maintain or change a condition in the environment or area being monitored.

The system, devices and method may be used for monitoring an environment, such as for example, gaseous, aquatic, or other environments. An exemplary implementation of the device and system involves monitoring a condition of humidity in a container. For example, monitoring humidity for regulating humidification of a cigar humidor, guitar case, or other container or area of interest, may be carried out using the system and devices. According to an aspect of the invention, a system and devices are provided for measuring the humidity within an enclosed structure or area, such as through a panel, or a building wall.

For example, in applications where moisture, such as humidity, is being monitored, the device includes a sensor which is positioned to measure the environment of a space which would otherwise be inaccessible, e.g., humidity, within the container, such as a humidor where items are kept.

According to some embodiments, the sensor may consist of multiple sensors for monitoring a number of conditions. For example, the sensor or sensors may measure humidity, light, air quality, ethanol, or other chemical presence or level (e.g., some examples including a hygrometer, photometer, ethanol sensor, or combination thereof). The sensor which preferably comprises a detection component for detecting the sensed condition, e.g., such as moisture (e.g., with a hygrometer sensor). The detection component, in the implementation where humidity or moisture is to be sensed, preferably comprises a hygroscopic sensor. The sensor is electronically connected with a transmitting component to transmit the sensed information to a computing device (such as for example, transmitting the sensed condition of a level of humidity, a chemical or composition concentration, a photonic reading or other condition detected by the sensor). The computing device that receives the sensed information may be a computer, or a mobile computing device, such as, for example, a phone, tablet, PDA, and preferably is configured to receive information that includes measurable conditions of the environment being monitored (e.g., the location where the sensor is disposed). The computing device may receive the sensed information directly from the sensor or through a network that the sensor communicates with. Readings from the sensor may be read in real-time and communicated to the controlling unit, or may be communicated at intervals (or near real-time). According to preferred embodiments, the sensor component preferably is configured to provide the environment information within a space (e.g., a humidor) through a wireless connection made to a network component, such as, for example, an access point, router, node, and may be communicated through a wireless protocol such as Wi-Fi, Bluetooth, or other wireless communication mechanism. Alternatively, according to some embodiments, the environment information may be communicated through a direct wireless connection to a computing device.

Embodiments of the system and devices may comprise a sensor electronically coupled with a first coil to receive power wirelessly from a compatible second coil (controller coil), and the sensor also may display the sensor readouts on a display. Preferred embodiments are implemented with or may be configured as a containment unit, such as for example, a terrarial or aquatic habitat (e.g., terrarium, aquarium), or structure that is provided with the sensor. According to some embodiments, optionally, there is wireless communication capability within or associated with the sensor that is configured to communicate the sensor information for readout on a device, which may be a device other than the optional sensor display. For example, the sensor and sensor circuitry may be configured to communicate wireless signals that provide the information about the sensed condition, as well as an identity of the sensor or device being monitored.

According to preferred embodiments, the sensor is placed within a containment or location being monitored, and the controller coil outside of the containment or location, or in some operably spaced apart manner (i.e., within the coil radiance or signal range) from the sensor. According to some implementations and embodiments, a containment or area may include two compartments or zones, one for a coil controller and the other for a sensor. For example, the coil controller and sensor could be in a containment but separated by a wall or panel, or a first zone may be on one side of a wall or separator, and a second zone may be on the opposite side thereof. For example, in a closed structure, a sensor may be mounted or installed on the inner side or area bounded by a wall structure or other panel (which may not be or may no longer be accessible after construction or after the panel is installed). The coil controller may be used on the wall or panel side opposite that of the sensor, to obtain information from the sensor. The coil controller may be positioned temporarily at the location (on the opposite wall or panel surface of the sensor) to obtain information provided by the sensor. The temporary positioning may be for a duration of a single reading (or set of readings), or may be positioned for hours or days, or longer). For example, in the case of a single reading or set, a coil controller may be manually positioned to obtain the reading from the sensor (or cause the sensor to communicate that reading to a device, where the receiving device is the coil controller unit, or some other computing device). Alternatively, the coil controller may be mounted (e.g., removably mounted) proximate the sensor location to have the sensor information generated over a period of time, or time interval (which can be hours, days or longer).

In another embodiment, the sensor may be placed within a container or across a wall as in the aforementioned embodiment, however, it may rely on a controller coil as part of a computing device which is disposed to provide power wirelessly to the sensor.

The system and device according to some embodiments provide a sensor which preferably is configured to be positionable within a containment or inaccessible environment and transmits through the existing containment walls and/or structure. According to preferred embodiments the sensor is powered without the requirement for batteries, allowing placement of the sensor within the containment without having to access the containment to change batteries (or to change a power source). The sensor is powered through a wireless powering circuitry through an associated controller which preferably resides on the exterior of the containment or structure (such as a wall, compartment or panel), while the sensor remains within the containment or structure (such as on the other side of the wall, compartment or panel). The sensor receives power wirelessly, and also sends and receives signals, including the environment condition or conditions being monitored. For example, the conditions may include information about the temperature of the sensor location (e.g., area, zone or containment) with one or more other conditions, using the wireless power to carry out the functions of the sensor.

According to one implementation, relating to monitoring moisture or humidity, the sensor comprises a sensor unit that includes a sensor that measures moisture and is configured to provide the information to an associated component that transmits the information, for example, through a network to a remotely situated computing component, such as, a mobile device. According to preferred embodiments, the controlling unit may be positioned outside of the sensor location area or containment in which the moisture condition is being monitored, and may comprise a controller that controls and powers the sensor. A sensor unit may be configured with multiple sensors, and the controlling unit may receive data from the sensors. In embodiments where there are multiple sensors, the sensors may be configured to communicate through an associated component. For example, the sensors may be configured to communicate data via a shared data bus. Associated circuitry also is provided in the sensor unit and controlling unit. According to some embodiments, the sensor is actuated by the controller to provide a monitored condition signal or value, such as a humidity reading via a signal (in the case of moisture monitoring). The signal may be obtained by or provided to the controlling unit from the sensor unit. The controlling unit may include a transmission element for transmitting the humidity information to a computer or a remote component. The condition information (such as for example, humidity in an exemplary implementation) may comprise a signal that is transmitted through the Internet, Wi-Fi, LAN, WAN, VPN or other network, to a remote device that is configured to display the humidity and/or process the information for storage or other usage. The signal may comprise the condition value or information obtained from the sensor, such as for example, humidity data from the sensor within a containment being monitored for moisture.

Embodiments of the device may be configured to receive, store and process data in accordance with instructions, which may be provided in software containing the instructions. The software and instructions may be on the sensor unit, the controlling unit, or both; or in addition, or alternatively, may be provided on a remote computing device that is to receive the signal data that the sensor and/or controlling unit relays. The condition data sensed by the sensor may be stored throughout periodic intervals and may be made available to review and recall at a later time. According to some embodiments, the devices and system may provide real-time or near real-time processing and monitoring of the sensed or monitored conditions within the containment or structure (e.g., wall or zone) so a viewer may view them. For example, a user may monitor conditions when an adjustment is made to the containment or to the area or zone being monitored by the sensor. For example, where the containment has been opened or accessed and therefore unseals its containment environment, the monitoring may take place to determine when or whether equilibrium within the containment is reached. For example, in an implementation where humidity is monitored, and desired to be maintained at a level, such as a humidor or case (e.g., guitar case) the monitoring may be used to determine whether addition of water or other humectant is needed, so the user can ensure or monitor the hygrostatic equilibrium (which may be a matter of minutes, hours or days). For example where a sensor is mounted on a structure, such as an interior wall panel, which is monitored, continuous monitoring may be useful to determine whether a remediated condition, such as a roof repair, broken pipe repair or other action, has been effective (e.g., by determining the reduction of moisture being sensed). For example, the sensor also may be disposed to measure and monitor fuel combustion gasses, in a wall where a chimney or flue is located. The monitoring may be done periodically (e.g., for inspections) or may be carried out continuously over time intervals. The sensed information may be communicated to a computing device. The computing devices receiving the sensed information, such as condition values, may be configured with software that displays these values, as well as alerts when a value is within or below or above a threshold value or range. According to some embodiments, an alert condition may be generated by the software or application operating on a device that receives the monitoring signals from the sensor.

In addition, the system and devices also may indicate when a condition has changed, such as accessing the container or structure being monitored, or if a seal sealing the container environment or wall zone or area has failed or leaks (e.g., such as the container cover and body), or other event that would affect the value of the condition being monitored (e.g., humidity, temperature, the presence or concentration of a substance).

Embodiments of the system and devices may provide a software application that is operable on a computing device, such as, for example, a smartphone, tablet or other device, which allows a user to view conditions of the container on the device display. The software may contain instructions for detecting and determining threshold levels, which may be set or preset, for humidity levels, light, temperature, presence or concentration of a substance (e.g., high, low, desired), and also for generating alerts, which may be communicated, displayed, sounded (i.e., audible), or coupled with an alarm mode or tone. In addition, the system and devices may be configured to communicate the sensed information to one or more other devices. For example, devices that are designed to respond to the condition or level sensed, such as a heater or refrigeration apparatus to provide heating or cooling, humidifiers/dehumidifiers to generate humidity or remove humidity from the air, may be operated in conjunction with the wirelessly powered sensor, to operate to regulate one or more conditions within the containment or area (e.g., zone) being monitored based on the information provided by the sensor.

According to some alternate embodiments, the system is associated with one or more mechanical devices whose operation may be determined based on the information provided by the one or more sensors. For example, a mechanical operator may move a panel to open or close the panel relative to the zone or area covered by the panel in order to address a condition, and/or to restore equilibrium of the condition (e.g., temperature, humidity).

The system and devices may be configured for application to an existing wall, panel or structure, or alternately, a wall, panel or structure may be provided with the sensor system. Alternatively, a wall or panel or other structure may be provided that is prepared to receive the sensor within an area or space (e.g., a zone), or where the sensor is disposed within a container wall. The sensor may be placed within a wall or other area or zone, and the sensor controller positioned or mounted on the exterior of the wall or area or zone (e.g., on a panel or structure bordering the zone), and preferably, within proximity of the sensor, so that the controller may power the sensor wirelessly, as well as receive or exchange information with the sensor. Additionally, a computing device which has wireless power transmission means may also be used to power the sensor wirelessly and then exchange information with the sensor. According to some preferred embodiments, the controlling unit may be removably mountable or connectable to the wall.

According to some embodiments, the sensor unit may be removable. The controlling unit and sensor unit may be provided for use with an existing wall or structure, or commercially available container, while according to other embodiments, the container or other structure is provided configured with one or more of the sensor or controller.

According to some alternate embodiments the sensor unit may be provided within the wall, panel or structure to be partially or wholly within the wall's, panel's or structure's thickness (and/or with one or more openings in the panel or structure for communication with the inside area of the wall). In some implementations, the sensor may be placed on the interior of the panel or surface so it is within the environment being monitored. A slot or panel may be provided in the wall, panel or structure to receive the sensor unit. According to some embodiments, a wall is provided having a space within itself (or bottom or cover) that is configured to receive the sensor unit. Alternatively, a holder may be provided or the sensor unit may be configured within a holder that first within the space of a wall, bottom or cover, and secures therein.

The devices such as the controller unit and sensor unit may include a screen or other display, such as a panel or window, that displays a reading of the sensed condition, such as the humidity that the sensor unit determines (e.g., 68.4%). The display panel associated with the sensor unit may be provided on the sensor unit housing, and a display may be provided on the controller unit housing. The display may also display other indications, such as temperature, and/or time, date (e.g., a clock).

According to some alternate embodiments, a display panel may be located at other locations on the containment/wall, and connected to display the sensed conditions of the inaccessible environment.

According to some preferred embodiments, a computing component is provided and configured with instructions for managing information and storing information. A user may implement the system and carry out the method using a personal computing device such as, for example, a tablet, smartphone or other personal computing device. A personal computer also may be used. The computing component preferably includes a processor, which may be a microprocessor or circuitry including a processing component. The smartphone or tablet may be configured by installing software on the device that contains instructions for managing information. This may be carried out for one or more containments, or may be provided without regard to the containment. Preferably, each containment/surface in which the user may store contents may be tracked separately as to its contents, and an inventory may be recorded and maintained as items are added to or removed from the containment (e.g., adding/removing cigars from a humidor). The environment conditions of the containment/surface also may be monitored and stored, and correlated with changes made to the containment, such as modifying the environment, or adding/removing items.

The sensor is configured to monitor humidity, and according to some alternate embodiments may be configured to monitor temperature. A temperature sensor may be included in conjunction with the hygrometer sensor, or may be separately provided and configured as part of the internal sensor or detecting device or circuitry.

The sensor unit may be configured with a camera in addition to or as part of the sensor.

The device may be used in shipping containers to track contents and the environment inside the containers which may not be accessible otherwise. The device may also be used within buildings, preferably across walls to monitor conditions inside the walls without cutting them open. This is especially useful to detect excess humidity or undesirable gas levels. In homes, it may be especially useful to place the sensing portion of a device on the ceiling of a crawlspace so that the sensor may be powered through the floor of a home when conditions are desired to be measured.

The devices preferably may be configured to report the information sensed by the sensor over a network. Embodiments provide networking capabilities, such as a transceiver, antenna or Wi-Fi capabilities for integration with a software application that handles the data from the sensor. For example, the humidity condition within the containment, such as a humidor, may be monitored over a time period (minutes, days, months), and can be stored and saved. In addition, the software is configured to process the information from the sensor to determine when a threshold condition, such as too low or too high humidity/temperature is present, and provide a warning. According to some embodiments, where a regulating device, such as a humidifier/dehumidifier is provided, the sensed condition may be used to control the operation of the humidification/dehumidification device, so as to regulate the humidity in the containment (e.g., the humidor) to the desired level.

These and other advantages may be provided by the invention.

### BRIEF DESCRIPTION OF THE DRAWING FIGURES

FIG. 1 is a depiction of an exemplary network setup with the device.

FIG. 2 is a depiction of an exemplary network setup with the sensing portion of the device powered in conjunction with a computing device.

FIG. 3 is a schematic illustration of the controller unit showing a preferred embodiment of the controller circuitry configuration.

FIG. 4 is a schematic illustration of the sensor unit showing a preferred embodiment of the sensor circuitry configuration.

FIG. 5 is an illustration of exemplary implementation of the system on a surface.

FIG. 6 is a side view of the device being used on a surface.

FIG. 7 is a side view of the sensing portion of the device being used on a surface in conjunction with a computing device.

FIG. 8 is a perspective view of the controller unit.

FIG. 9 is a rear elevation view of the controller unit.

FIG. 10 is a perspective view of the sensor unit, as viewed looking at the mounting side of the unit.

FIG. 11 is a front elevation view of the sensor unit.

FIG. 12 is a front elevation view of a boat with the applied device.

FIG. 13 is a front view of a building wall with the device being operated by a user.

FIG. 14 is a side view of a building wall with the device being operated by a user in conjunction with a computing device.

FIG. 15 is side view of a shipping container with the installed device being operated by a user in conjunction with a computing device.

FIG. 16 is a side view of a shipping container with the installed device being operated by a user.

FIG. 17 is a view of a beer/wine vat with the device installed.

FIG. 18 is a view of a beer/wine vat with the device being operated by a user in conjunction with a computing device.

FIG. 19 is a view of a computing device screen using provided software instructions to interact with the sensor system.

### DETAILED DESCRIPTION OF THE PREFERRED EMBODIMENTS

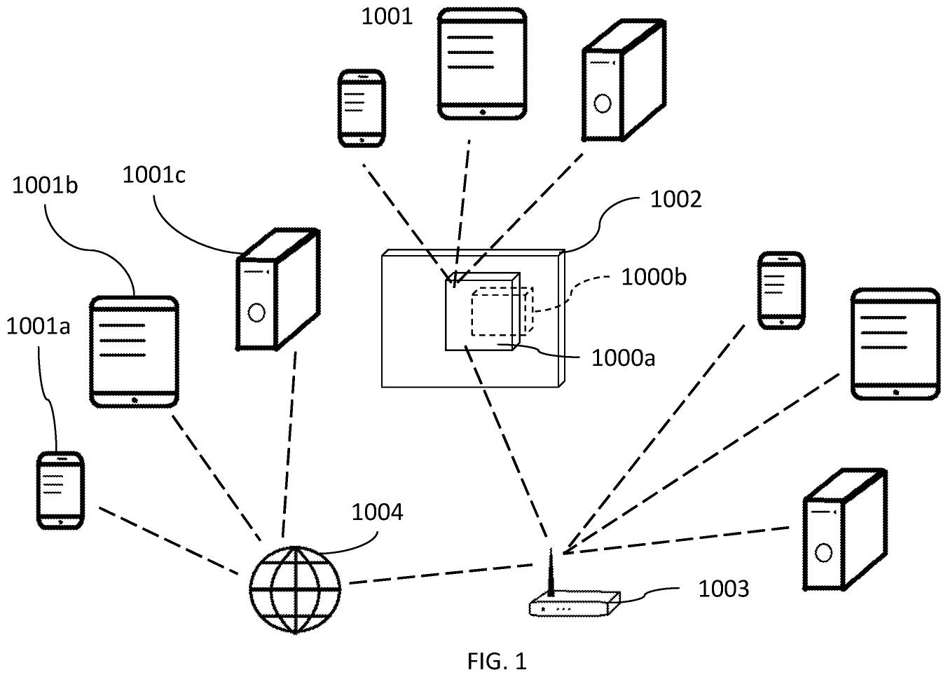

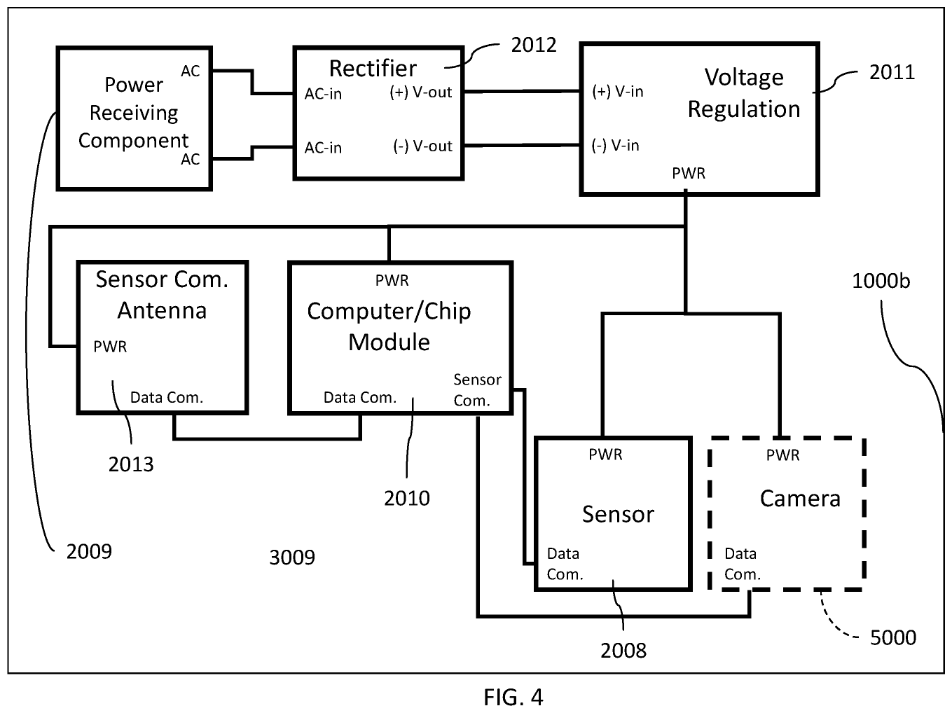

A system for monitoring an environment or area. Referring to FIGS. 1-4 the system is illustrated comprising a sensor unit 1000b with circuitry that contains a sensor 2008, a camera 5000, and a power receiving component 2009 (FIG. 4) for receiving wireless power from a controller unit 1000a or configured computing device 1001 that when positioned proximate to the sensor unit 1000b powers the sensor circuitry and the sensor functions. While referred to as “sensor”, the sensor 2008 may be a plurality of sensors. The sensor unit 1000b is configured to provide wireless communications to report the data sensed by the sensor 2008 so that the condition of the environment bounded the wall 1002 may be monitored. The system is illustrated in an exemplary embodiment with a panel or wall 1002, where the sensor unit 1000b is disposed on an inaccessible side of the panel or wall, and the controller unit 1000a is disposed on an accessible side of the wall 1002. The controller unit 1000a is also adjacent to the sensor location to provide wireless power to the sensor. The sensor unit 1000b does not require batteries, and one is not required to access the other side of the panel, wall or surface 1002 in order to obtain the readings or to provide power to the sensor unit 1000b. The monitoring may be carried out locally by reading the display associated with the device, such as on the controller unit 1000a (or in addition or alternately, on the sensor unit 1000b).

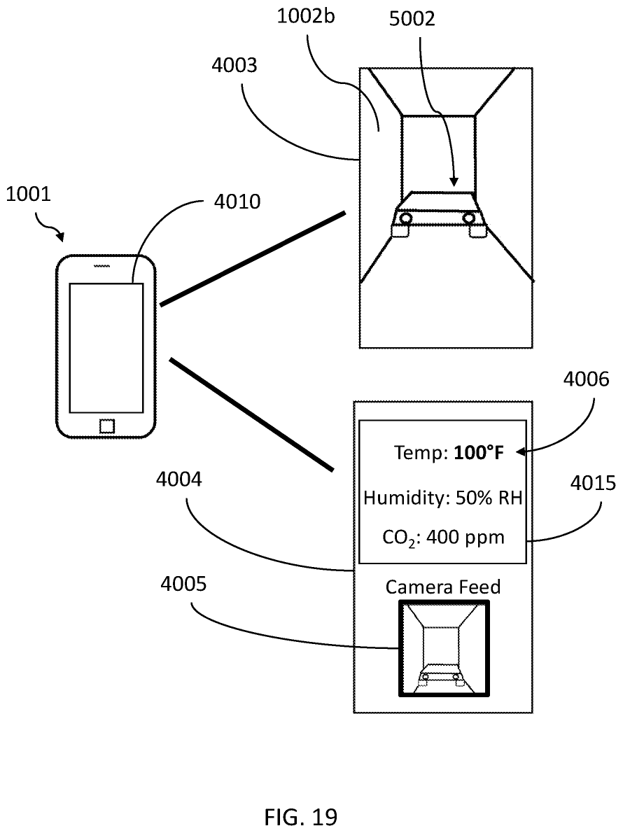

Referring to FIG. 1, a system, method and devices for monitoring a condition within an environment or area bounded by a panel or wall are illustrated according to a preferred implementation in conjunction with a computing component or device which, in the embodiment depicted, may be a smartphone 1001a. An application, such as a software application, preferably is provided on a smartphone 1001a, and may be configured to receive inputs from a user, and according to preferred embodiments, may be configured to receive information about the conditions of the environments or area bounded by the panel or wall 1002. The panel or wall 1002 may comprise an enclosure, or may define a boundary between one side of the wall or panel 1002 and what is on the other side (e.g., an environment or area). The information of the monitored environment or area may be associated with an identification of the environment or area, such as a designated space, which the user may name through the use of the application to assign a unique reference, such as a name, number, character or combinations thereof. The designated area information may also include properties of what is being monitored, such as, for example, humidity, temperature, presence of activity or an object, gasses, water, and other measurable characteristics. The information is communicated to the computing device, such as, for example, the mobile phone or smartphone 1001a depicted in FIG. 1. The smartphone 1001a receives the information ascertained by the sensor unit 1000b disposed to sense humidity within the area being monitored, such as the other side or the panel or wall 1002. Preferably, the sensor unit 1000b comprises an electronic component that provides a signal in response to the humidity sensed. The sensor unit 1000b in the embodiment shown is disposed within the wall 1002 to sense humidity. The sensor unit 1000b provides information to a communication component, which in the embodiment illustrated, comprises a wireless transmitter, such as, for example, Wi-Fi communication circuitry that transmits the information to the smartphone 1001a. The smartphone 1001a is provided with instructions to receive the hygrometer information, and preferably, the smartphone 1001a is provided with software that is configured with instructions to process and manage the information. The software preferably includes instructions for receiving and storing the information provided by the sensor, which identifies the humidity within the wall 1002. The information from the sensor unit 1000b is processed and made available for the user to view on the display screen 4010 of a computing device 1001 (see FIG. 19). According to some embodiments, the sensor 1000b may be configured in a circuit where a signal from the smartphone 1001a is generated and communicated to the sensor control circuitry to activate the sensor circuitry to record the information that the sensor is designed to sense and to communicate that reading, image and/or other information, or otherwise make it available to the smartphone application. The information from the sensor may be stored and associated with a date and time taken, as well as the identification of the sensor circuitry associated with its containment (such as, for example, “Sensor Monitor No. 1”). Alternatively, the sensor may be configured to report the signal to the computing device, such as the smartphone, periodically, such as real-time, near real-time, or at a pre-determined or desired interval).

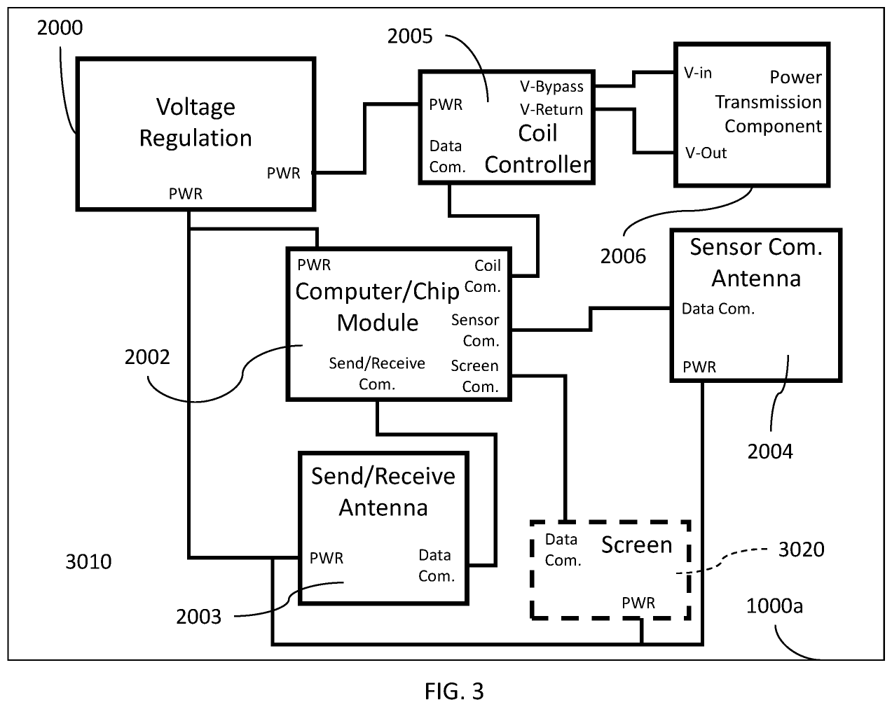

An exemplary embodiment of a system is shown in FIG. 1, and represented in FIGS. 3 and 4 depicting respectively, a controller unit 1000a and a sensor unit 1000b.

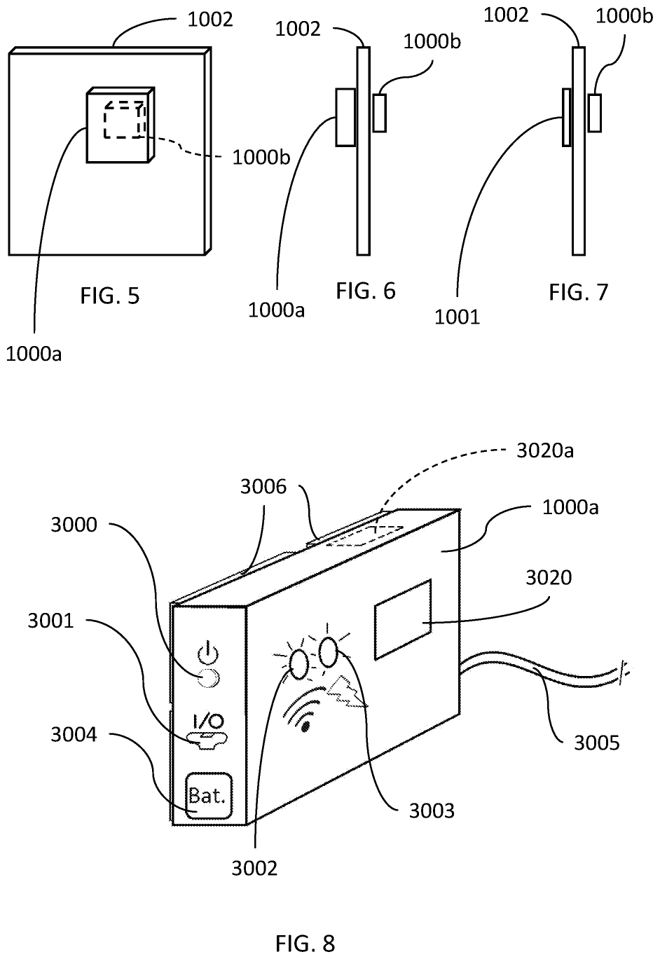

Referring to FIG. 3, a controller is shown comprising the controller unit 1000a which includes circuitry 3010 configured to power and operate the sensor unit 1000b (see FIGS. 4 and 5). According to preferred embodiments, the controller unit 1000a includes circuitry that operates and communicates with the sensor unit 1000b and the sensor circuitry 3009 (FIG. 4). In the exemplary embodiment illustrated, the controller circuitry 3010 is shown comprising a voltage regulator 2000, a computer/chip module 2002, an antenna for exchanges of wireless data transmission 2003, an optionally separate antenna 2004 for communication with a sensor 2008 in sensing unit 1000b or solely therewith, and a wireless power transmission component 2006 which may be controlled and regulated by a regulator, such as the coil controller 2005. Though not shown, an oscillator and switch may be configured in conjunction with the coil controller 2005 or may be part of the coil controller. The separate antenna 2004 may be optional where the antenna 2003 provides communications exchanges for wireless data exchanges with the sensor 2008. The embodied power transmission component, depicted comprising a coil 2006 may be used to provide power to the sensor unit 1000b by transmitting power to the sensor power receiving coil 2009 therein (FIG. 4). The controller power transmission component 2006 transmits power through wireless inductivity. The power transmission component 2006 preferably contains circuitry comprised of an electrical coil through which an oscillating current may flow. The frequency and amplitude of the current may be controlled by associated circuitry 3010 of the controller unit 1000a (FIG. 3), including the coil controller 2005. According to some embodiments, the coil controller 2005 contains an oscillator that may also be used in order to provide switching for the circuitry of the power transmission component or coil 2006. The frequency of the current switching may be regulated and controlled by the coil controller 2005. For the transmission of wireless power, the power transmission component 2006 of the controller unit 1000a and sensor power receiving component 2009 of the sensor unit 1000b each embody at least one electronic coil. According to preferred embodiments, the frequencies of oscillation in the respective transmission component circuitry (e.g., the circuitry 3010 of the controller 1000a) and receiving component circuitry (e.g., the circuitry 3009 of the sensor 1000b) are matched. For the transmission of power wirelessly, the transmission component 2006 (FIG. 3) and receiving component 2009 (FIG. 4) may utilize concepts of inductive resonance and embody circuitry that may be configured to oscillate at matching or resonant frequencies. The coil controller 2005 preferably embodies circuitry, and according to some embodiments, the circuitry allows characteristics of the power transmission component or coil 2006 to be altered in real-time, such as the frequency of the oscillating current flowing through the component or coil 2006 or the amplitude of the current. The coil controller 2005 may alter the aforementioned characteristics based on instructions contained in the software or circuitry provided in the computer/chip module 2002, where the instructions contain a method to adjust characteristics of the power transmission component or coil 2006 to achieve optimal power transmission. For example, the controller unit 1000a may be powered on by the user, and it may not initially detect sensor unit 1000b or a wireless connection thereto; it is possible that the respective power components, such as the coil 2006 and sensing component coil 2009 do not resonate at compatible frequencies (due to component tolerances, manufacturing inconsistencies, or other variations) or that they cannot establish a strong enough power connection (e.g., they are too far apart, or there is too much material between them, or the type of intermediary material). In the aforementioned case or situation, the coil controller 2005 may alter the following characteristic of the power transmission coil 2006 until a data connection with sensor unit 1000b can be established: The oscillation frequency may be altered by increments, positively and/or negatively until a connection is established. If a connection is established after having altered the frequency, the new frequency value may be saved and stored to the computer/chip module 2002 (FIG. 3) to be recalled for the next time the coil controller 2005 is activated. A stored value, such as a stored frequency value, may be implemented to facilitate operations of the wireless power circuitry compatibility. The value of the aforementioned frequency may be stored as a representation of the new frequency, e.g., in hertz or its period in seconds, or it may be stored as some new value which represents that of the component altered for the frequency change, e.g., the new resistance of an adjustable element, such as, for example, a digital potentiometer. The value of the aforementioned frequency may also be stored as a value which represents that required to adjust some component to achieve the new frequency (e.g. the voltage required to adjust a digital potentiometer). An indicator, such as a diode or light on the sensor unit 1000b shows power-connectivity strength, such as, for example, by changing hues from green (good connection) to red (bad connection).

While it is in theory desirable (for efficiency and strength of the wireless power signal) to have matching resonant frequencies in the power transmission component 2006 circuitry and the power receiving component 2009 circuitry, the coils and capacitors included in the circuitry may be substituted with coils and capacitors which (when used in the same manner as described previously) will cause the circuitry of the power receiving component 2009 to have a resonant frequency which is a proportion of the driving frequency (e.g. ½, ¾, 3/2, etc.). It may be beneficial to have the resonance of the coil circuitry of the controlling unit 1000a (the driving coil circuitry) not match the resonance of the coil circuitry of the of the sensor unit 1000b in order to limit power consumption and the potential for excessive heat generated from wireless power transfer.

The embodiments of the controller unit 1000a contain a voltage regulator 2000 which provides power for the controller circuitry 3010. The regulator 2000 may receive power from an external means of an electrical socket, an internal battery, replaceable and rechargeable by the user, or by wireless power transmission. The regulator 2000 comprises circuitry which regulates voltage and current to proper amounts in order to appropriately provide power to respective components that require it. For example, the following components may receive voltage regulated power via the regulator 2000, among which include: Coil Controller, Sensor Communication Antenna, Send/Receive Antenna, Display Screen. (see FIG. 3). The PWR abbreviation indicates a DC power and ground connection, and may consist of multiple separate power and ground connections. The Com. abbreviations represent electronic connections for exchange of data. While some parts of the described circuits in FIGS. 3 and 4 contain multiple nodes with “Com.” abbreviations, the nodes may either all share the same data bus or all have their own individual data connections.

The computer/chip module 2002, depicted in FIG. 3 may be comprised of circuitry that is programmable by software. Microcircuitry, microprocessors, microcontrollers or embedded logic, are examples of circuitry or circuit components that may be provided with instructions for processing, storing, and/or communicating information, and which may comprise the computer chip or module 2002. The software may contain instructions to communicate with sensor unit 1000b (shown in FIG. 5) and the relevant components contained therein, including but not limited to a separate computer/chip module 2010 and a sensor 2008 of the sensor unit 1000b and circuitry 3009. The computer/chip module 2010 is similar to the computer/chip module 2002 in that it may also be provided with instructions for processing, storing, and/or communication information. The sensor 2008 preferably consists of a humidity sensor that is equipped to measure characteristics of its surroundings such as humidity, as well as, according to preferred embodiments, temperature, light penetration, and gas concentration. The computer module 2002 may also contain software that includes instructions for sending and receiving data to an external computing device 1001 through wireless means, facilitated by an antenna 2003, as well as instructions to process incoming data requests from the devices. The computer module 2002 may also contain instructions to process data received from the sensor unit 1000b, facilitated by a dedicated sensor communication antenna 2004. Antennas also may be configured comprising or associated with transceivers for receiving and communicating information and/or data. Embodiments also include a computer module 2002 that is configured with the capability to record and store data, including data and/or other information received from the sensor unit 1000b and from devices that connect and interact with the controller unit 1000a, including but not limited to a computing device 1001 or a network switch 1003. For example, the data may include user-settings, the local and external IP address of the portion of the device (e.g. the sensor unit 1000b, the controller unit 1000a, the computing device 1001, or a combination of the three) which is connected to the internet 1004 and/or a network switch 1003, and logs of data from sensor unit 1000b, for example. The computer module 2002 may also contain instructions to interact with a power controller 2005. The interactions include the ability to monitor real-time characteristics of the controller 2005 such as power consumption and oscillation frequency, for example, as well as the ability to alter characteristics of the circuits that are regulated by the controller 2005, including the circuitry embodied by controller 2005.

The computer module 2002 may also interact with servers or web applications hosted through the internet 1004 via the network switch 1003 (FIG. 1). Referring again to FIG. 1, an external computing device 1001 may interact with the data servers or web applications via the internet 1004 by running a compatible software application.

Upon the receipt of a data-request from an external computing device 1001, the controlling unit 1000a may enter a “live” state and leave a previous “sleep” state. In the contents of the request, instructions will be contained that describe what the computing device 1001 is requesting, and the computer module 2002 will comply and perform actions based on the received instructions. For example, instructions may include an operation, such as instructions to change settings (monitor-interval, IP address, etc.), instructions to pull telemetry data, stored or real-time, or another function. The controlling unit 1000a may also periodically check via the internet 1004 whether a computing device has an unacknowledged request and will perform actions based on the unacknowledged request.

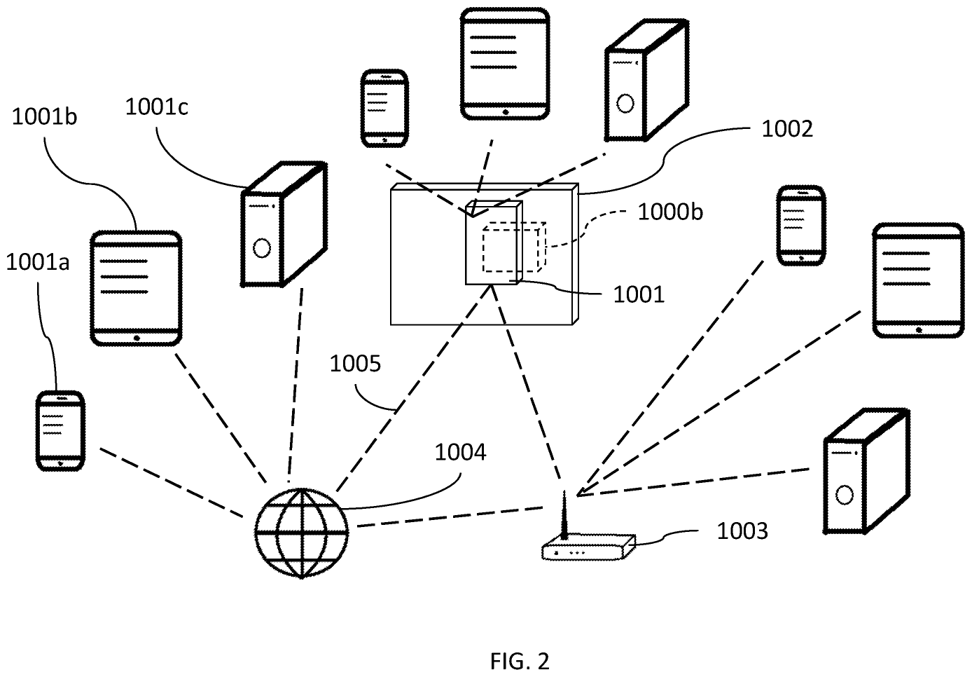

Referring to FIG. 4, according to an exemplary embodiment, the communications circuitry 3009 of the sensor unit 1000b is shown comprising a voltage regulation component 2011, a computer/chip module 2010, an antenna 2013 for wireless communication exchanges with a computer module 2002 in the controller unit 1000a. Alternatively, or solely with the component, a wireless power receiver component 2009, a power rectifier component 2012, and a sensor 2008. The embodied power receiving component 2009 of the sensor unit 1000b may provide power to the sensing component circuitry 3009 via wireless inductance between the power transmission component 2006 of the controller unit 1000a shown in FIG. 2.

Alternatively, the power receiving component 2009 may contain circuitry which allows it to be compatible with an existing wireless power standard as a receiving component to receive power for the sensor unit 1000b. Referring to FIG. 2, a computing device 1001, which is configured to provide wireless power, either through internal electronics or an external attachment (i.e. a USB-powered charging-pad) may power the sensor unit 1000b by interacting with the power receiving component 2009. The communication antenna 2013 of sensor unit 1000b may be configured to communicate directly to the computing device 1001 that is powering it by means of Wi-Fi, Bluetooth, or other wireless means. The computing device 1001 may communicate the data received from interacting with the sensing component 1000b via a direct cellular data connection 1005 to a server or other computing device 1001. The computing device 1001 may also communicate the received data directly to another computing device 1001 as seen in FIG. 2.

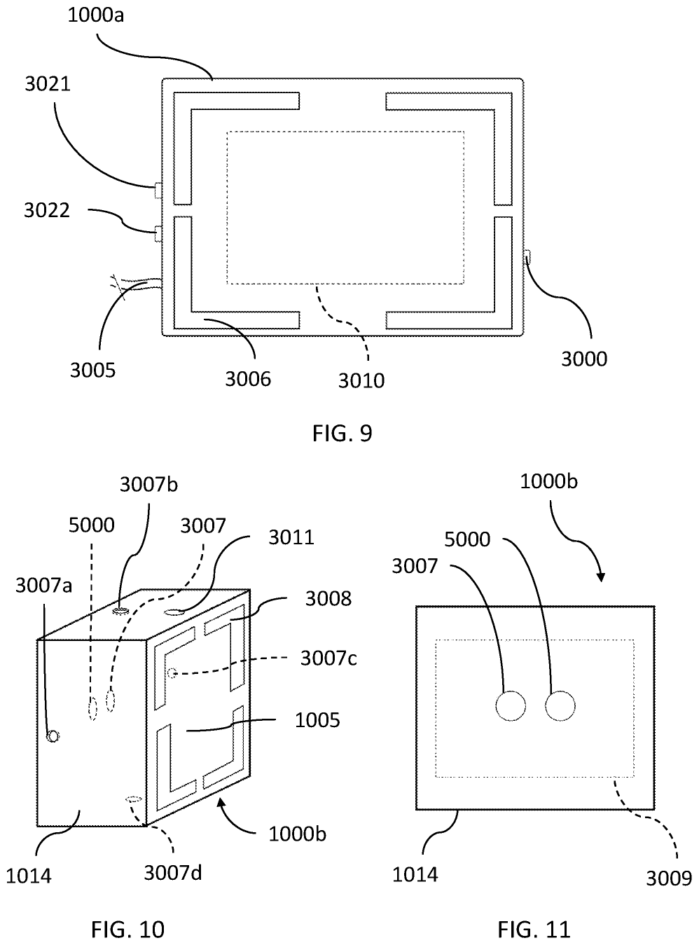

Referring to FIGS. 5 and 6, the sensor unit 1000b is shown disposed across a surface 1002. The controller unit 1000a is shown disposed on the accessible side of the surface 1002. The sensor unit 1000b monitors multiple conditions (e.g. light, humidity, temperature, visuals, gas concentrations) of its surroundings. In the embodiment illustrated, the sensor unit 1000b is on the inaccessible portion of the surface, and the controller unit 1000a is disposed on the accessible side of the surface. In the arrangement depicted, the controller unit 1000a wirelessly powers the sensor unit 1000b. The sensor unit 1000b includes circuitry that communicates wireless signals of the monitored conditions in the interior-side of the surface or panel based on the sensor detection. The sensing component 1000b may also comprise a camera 5000 that takes a snapshot or video clip of the inaccessible environment when it is being wirelessly powered. The controller unit 1000a may be mounted on an accessible portion of the surface 1002 (and may be removably mounted so it can be detached and attached as desired) using adhesive pads 3006 (FIG. 9). Alternatively, in place of adhesive pads, other suitable mounting elements may be used. The controller 1000a has circuitry that is configured to receive or exchange wireless communications between the sensor unit 1000b, the communications including wireless signals of the conditions that are detected by the sensor or signals of visual data collected by the camera 5000. The controller unit 1000a also may be configured to instruct the sensor unit 1000b when to detect the signals, and when to report the detected signals. The controller unit 1000a is powered by a power source which may be any suitable power source, such as for example, a battery or supplied electrical power from an electrical utility, solar power (from a solar cell), wireless power, or other suitable power.

The sensor and controller are designed to operate in conjunction with devices, such as a device that may operate to regulate a condition within the environment or area, including the measured characteristics of the environment or area being monitored. The circuitry of the sensor, controller or both may be configured to communicate with the device that operates to regulate a condition within the environment or area (e.g., such as a humidifier or dehumidifier, light, heater), and may provide instructions or inputs (humidity signal) in response to conditions within the containment that are sensed by the sensor.

For example, where the sensor is a hygrometer, a humidifier or dehumidifier are configured to operate so that the hygrostatic condition within the containment (humidity) is regulated and controlled to a desired level. The humidifier or dehumidifier preferably include circuitry that operates the humidifier or dehumidifier (or both) in response to the conditions sensed with the sensor. According to some embodiments, the humidifier or dehumidifier includes a power source for powering its operations (i.e., distribution of humidity within the containment, or removal of humidity within the containment). According to some embodiments, the humidifier or dehumidifier is wirelessly powered to operate to deliver or remove humidity from the containment in response to a hygroscopic condition sensed by the sensor. The wireless power may comprise a controller situated to deliver wireless power to the humidifier or dehumidifier. According to some embodiments, the dehumidifier and humidifier may be provided as a unit. According to some other embodiments, the dehumidifier may be provided to operate the cover to open the cover to a slightly open position to allow humidity to escape, and close the cover, upon reaching the desired level of humidity as determined by the sensor. Alternatively, where the sensor is a thermometer, a device that may be used in conjunction therewith may comprise a heating or cooling device.

Referring to FIG. 8, an exemplary embodiment of the controlling component or controller unit 1000a is shown. As described, the controller unit may be powered via a power input in the form of input from an electrical adapter 3005 or battery provided in a battery compartment 3004. The battery compartment 3004 may be situated at the bottom of the device for better center-of-mass stability. On the front wall of the controller unit 1000a there is a display screen 3020. The display screen 3020 may be an LCD, LED, or OLED screen, or other suitable display. The display screen 3020 preferably is provided to display information, such as for example, some or all of the following: 1. telemetric data from the sensing component 1000b, 2. device information (i.e. time running, user info, or network information), 3. internet connection information (i.e. IP address, port info), 4. device and telemetric statistics, 5. user account information, and 6. a snapshot, video, or data provided from camera 5000. Alternatively, the location represented by 3020a is an alternative placement of the screen shown on the top of the controller unit 1000a, which may allow for more convenient user interaction. Controlling unit 1000a, in conjunction with sensing unit 1000b, may operate in a mode without the need for further computing devices, or both local mode and data transmission or remote mode. In the local mode, the controlling unit 1000a may display the information about the condition being monitored (e.g., humidity, image, temperature, light, or other condition) that may be viewed on the observable side of the panel or wall 1002, by providing that information on the display, such as the display 3020. There are also several buttons or controls on the device which allow for user-interaction directly at the device (e.g., local operation), separate from interacting with controlling unit 1000a or sensing unit 1000b through an external computing device 1001.

As represented in FIGS. 8 and 9, the controller unit 1000a has several controls, shown comprising buttons 3000, (FIG. 8), 3021 and 3022 (FIG. 9). The power button 3000 allows the user to toggle the control unit 1000a on or off. The refresh button 3021 (FIG. 9) allows the user to immediately read data from the sensing component 1000b if it is setup to sense data on timed intervals. The refresh button 3021 also allows for the manual refresh of data from the internet 1004 if it has not automatically been refreshed by the controlling unit 1000a (i.e., name change for device, settings change, etc.). A reset/config button 3022 is also situated on the outside of the controlling unit 1000a; When pressed, the controlling unit 1000a will enter a configuration or setup mode where the user can connect to the controlling unit 1000a or sensing unit 1000b via Wi-Fi or Bluetooth to perform a setup. Additionally, the button 3022 may have a second function, such that if it is held (i.e., depressed) for an amount of time, the button 3022 may act as a reset button for the purpose of resetting the controlling unit 1000a and sensing unit 1000b to factory settings and removing user-data including SSIDs, passwords, and telemetric data.

As represented in FIG. 8, a port 3001 for direct serial communication to the controlling unit 1000a is shown. The user may read data from the controlling unit 1000a or configure the device through a direct connection via the port 3001 via an external computing device 1001.

Further shown in FIG. 8 are status indicators, comprising lights 3002 and 3003. The Wi-Fi status light 3002 is used to indicate Wi-Fi connectivity, data sending/receiving, and device pairing status. The sensor power status light 3003 is used to indicate that the power transmission component 2006 is being powered and wireless power is being sent to the sensing unit 1000b.

As illustrated in FIG. 10, the sensor unit 1000b shown having a housing 1014 that contains the sensor 2008 and the circuitry 3009 therein. A mount, such as the adhesive pads 3008, similar to the adhesive pads 3006 on controller unit 1000a are shown provided on the rear surface 1005 of the sensor unit 1000b. Although illustrated as adhesive pads 3008, the mounting mechanism may in addition or alternatively, comprise magnets, or metal instead for creating a magnetic connection with the outer pads 3006. Other suitable mounting hardware or components may be used. In FIG. 10, a power status light 3011 is shown, and is provided to indicate the relative strength of the wireless power connection. The status light 3011 may show a change indicative of a condition. For example, the status light 3011 may have a peak lumens output when the sensor unit 1000b is receiving sufficient power, or may shift from red to green to indicate the same criterion or status condition. The power status light 3011 is preferably utilized during initial setup of the device if the device is not utilizing orientating magnetic connectors as 3006 and 3008. The indicator, i.e., status light 3011, may also be in use whenever the sensing component 1000b is being powered during use.

Also represented in FIGS. 10 and 11 is a shell opening aperture 3007, which allows moisture into the housing 1014 of 1000b for sensing. Additionally, the sensor 2008 of circuitry 3009 may be sealed against shell hole 3007 to prevent moisture from entering the housing 1014. Shell holes 3007a, 3007b, 3007c, and 3007d are optional holes to allow more entrance points for the surrounding environment or area to be measured. FIGS. 10 and 11 also show camera 5000 and its desired position in the housing 1014.

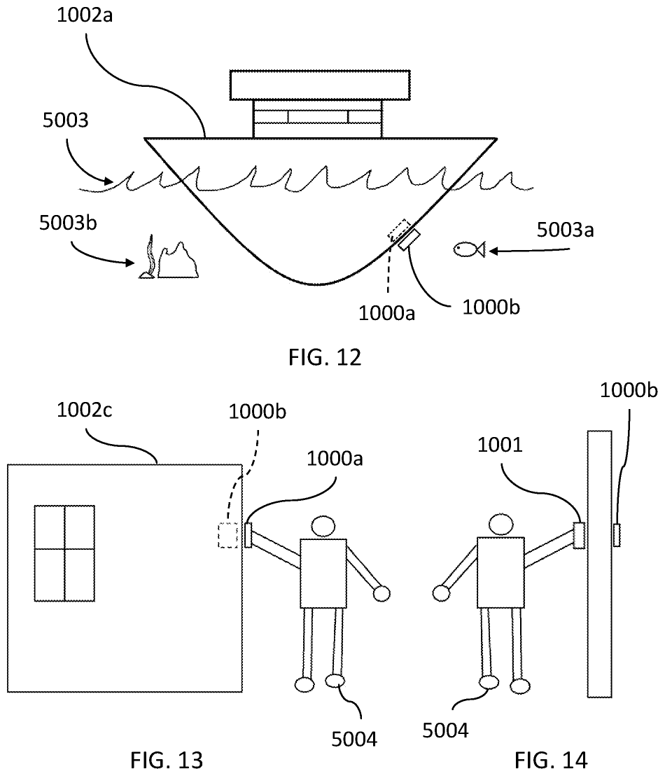

Represented in FIG. 12 are the control unit 1000a and sensor unit 1000b being used across the lower hull of a boat 1002a. The controlling unit 1000a is inside the boat's hull, and the sensing unit 1000b is in the aquatic environment 5003 outside of the boat's hull. The sensing unit 1000b is preferably secured to the hull by adhesive means. It may also be mounted to the hull with hardware, but this is not preferred (as a surface mounting that does not require disruption of the hull by boring or puncturing is preferred). The sensing unit 1000b may have sensors configured to detect aquatic obstacles 5003b or aquatic life 5003a. The wireless power from the controlling unit 1000a is transmitted through the thickness or width of the hull to power the sensing unit 1000b. The respective range of the controller unit 1000a delivers wirelessly signal that powers the sensing unit 1000b. According to preferred embodiments, the sensing unit 1000b transmits a signal comprising the sensed information through the hull back to the controller unit 1000a or other device that is to receive the signal from the sensing unit 1000b.

FIG. 13 represents operation of the devices through a building wall 1002c by an operator 5004. In this embodiment, the operator is powering the sensing unit 1000b with the controlling unit 1000a by holding it in proximity on the exposed portion of the wall 1002c. The sensing unit 1000b is configured to communicate qualities of its environment to the controlling unit 1000a which may process the data in accordance with software instructions. For example, conditions, such as moisture, smoke, heat and/or chemical presence may be monitored with the sensor (where the sensor is configured to detect or monitor the presence or levels of a substance).

Slightly different than FIG. 13, FIG. 14 depicts a side-view of the sensing unit 1000b being used through a building wall 1002c; however in this embodiment, the sensing unit 1000b is being powered by a computing device 1001 which is configured to transmit power wirelessly (e.g., a smartphone 1001a with a built-in power transmitting/receiving coil). The communication network as depicted in FIG. 2 may be utilized in this implementation.

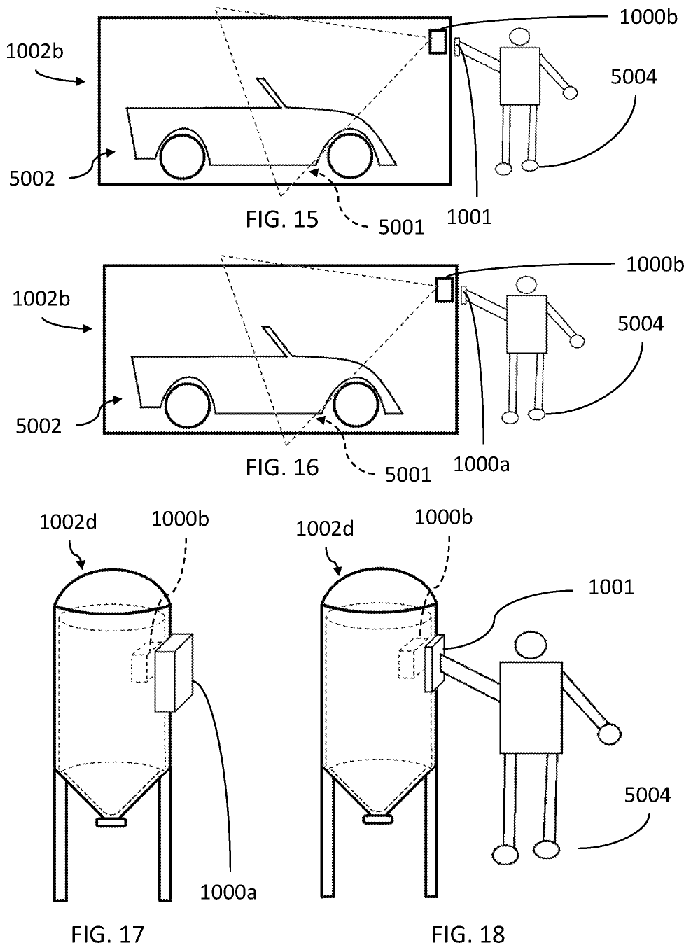

Represented in FIG. 15 is an exemplary implementation of the devices being used an operator 5004 through the wall of a shipping container 1002b. The operator is holding a computing device 1001 proximate the location of the sensing unit 1000b in order to power it wirelessly in a similar manner described for the embodiment of FIG. 14. The sensing unit 1000b is positioned inside the container 1002b, utilizing the field of view 5001 of the camera 5000 to save an image or video of the container contents 5002 (which in the current embodiment is represented as an automotive vehicle) The image may be transmitted in real-time or near-real-time to the powering-computing device 1001 to be displayed for the operator 5004 to see. Additionally, the sensor 2008 of the implementation may consist of multiple sensors to monitor other aspects of the environment (i.e., humidity, temperature, or gas contents).

Represented in FIG. 16 is the shipping container 1002c being monitored by an operator in a similar manner to the container of FIG. 15, however the sensing unit 1000b is being powered by the controlling unit 1000a. The sensing unit 1000b, when powered, will transmit a visual depiction of the contents 5002 to the controlling unit 1000a which may be viewed in real-time or near-real-time by the operator 5004 on screen 3020. In this type of embodiment, it would be advantageous to have the controlling unit 1000a powered by a battery for more convenient monitoring by an operator. The visual depiction may be an actual image, video, frame, or graphic representation of the sensed area and/or contents within the monitored space.

Represented in FIG. 17 is a fermentation tank/vat 1002d typically found in breweries or wineries. The device is configured where the sensing unit 1000b is inside of the tank and the controlling unit 1000a is outside of the tank powering the sensing unit. The sensing unit 1000b may be configured with sensors to measure gas concentrations, light diffraction/refraction, temperature, alcohol levels, or other environmental conditions.

In FIG. 18, the device is being used in a manner similar to that of FIG. 17; however, the sensing unit 1000b is being powered by a computing device 1001.

According to some embodiments, the sensor 2008 in sensing unit 1000b may consist of a plurality of sensors which are configured to communicate with computer module 2010 via a data bus. The camera 5000 may also communicate with computer module 2010 via the aforementioned data bus or through an independent connection.

Setting Up a Telemetry Connection

The user may navigate to the telemetry display page 4004 as shown in FIG. 19, via an external computing device 1001 (FIGS. 1 and 2). In the exemplary depiction, the screen display 4010, is shown depicting multiple displayed conditions which can be expanded. Telemetry may be displayed as information group 4015, through visual means such as a graphic display, which may comprise a gauge and/or text. In addition to populating the screen 4010 with data, sensor telemetry data may be asynchronously collected/gathered, if a telemetry connection has been set up by the user, and used to populate information group 4015. Depending on if and how telemetry data could not be sourced (whether within a timeframe or other circumstance), a notification or visual alert/text will notify the user the reason for lack of a telemetry connection. In the case that telemetry has not been set up for the respective wall, the aforementioned notification will encourage the user to set up a telemetry connection. In the case of lack of connection, the aforementioned notification will inform the user of such.

A method for initializing the telemetry screen FIG. 19 may be performed in accordance with instructions provided entirely, or in part, generated by the software and displayed on the screen for a user to follow. The telemetry connection may be established through Wi-Fi, internet, Bluetooth, or other means of wireless communication, the preferred connection type being dependent on which method may be most suitable at the time. Different wireless connections are illustrated in FIGS. 1 and 2, each of which preferably includes a computing device 1001, and either the controlling unit 1000a, the sensor unit 1000b, or both which communicate with each other. In accordance with some embodiments, the method may be carried out where a computing device, such as for example, the computing device 1001, establishes a connection, e.g., through means of an Internet connection 1004, to the either the controlling unit 1000a or the sensor unit 1000b. In accordance with some embodiments, the computing device 1001 may establish a connection with the controller unit 1000a or sensor unit 1000b through means of Wi-Fi over a LAN. In accordance with some other embodiments, the computing device 1001 may establish a connection with the controller unit 1000a or sensor unit 1000b through a direct wireless communication, such as Bluetooth or RFID. The system is configured so that the controller unit 1000a or sensor unit 1000b may establish a connection, which preferably may be an asynchronous connection, with the computing device 1001. Upon a successful connection being made between the computing device 1001 and the controller unit 1000a or sensor unit 1000b, data may be pulled or otherwise obtained from the controller unit 1000a or sensor unit 1000b. The data may be stored and processed, and preferably, the data is used to populate the telemetry screen, as depicted in the exemplary screen display represented in FIG. 19. Using a selector, such as a button on the computing device, or on the display screen 4010 (e.g., a touch screen), the user may switch the graphic representation of hygrometer data between humidity, temperature, or other values that are being measured by the sensor unit 1000b or determined by the controller unit 1000a.

The user may change telemetry settings by interacting with an application on a computing device 1001. The user may set bounds for out-of-range values for monitored conditions, (e.g. humidity too low/high). When conditions fall outside of these limits, a notification may be sent to an external computing device 1001.

FIG. 19 depicts different screens that the computing device 1001 may display to a user while interacting with the sensor. For example, the user may navigate to the camera page 4003 if the sensor unit 1000b is equipped with a camera. The camera page 4003 may display a live camera feed, previously captured images, or the most recent captured image taken by camera 5000. The camera screen may also be configured to appear by default when a computing device 1001 senses that it is powering a compatible sensor unit 1000b (e.g., to display an image or video).

The user of the application on the computing device 1001 may also navigate to the telemetry display page 4004. On this page of the application, information from the sensor 2008 may be displayed. In the embodiment of FIG. 19, temperature, humidity, and CO₂ content. If the sensor unit 1000b is equipped with a camera, images or video from the camera may also be displayed on the telemetry display page 4004 in a small view window 4005. When sensor values are out of range, the values may be displayed differently in order to alert the user. The temperature data 4006 is displayed differently than other values in FIG. 19 as an example of its being out of range.

In accordance with some embodiments, a telemetry system is provided for communication between a first location and a second or remote location. The first location preferably comprises the location at which the sensing component is located, such as, for example, a shipping container to be monitored. According to an exemplary embodiment, the panel or wall 1002 is illustrated in an arrangement with computing components, for communicating information. The panel or wall 1002 is illustrated with the sensing unit 1000b, and according to the embodiment illustrated, the sensing unit 1000b is shown carried on the panel or wall 1002. In several exemplary embodiments, the panel or wall 1002 is represented to comprise a boat 1002a, a shipping container 1002b, a wall or floor in a building 1002c, or a beer/wine fermentation vat 1002d. The sensing device includes circuitry for detecting one or more conditions, and preferably conditions within the area being monitored, such as, for example, relative humidity, temperature, light penetration. According to some implementations, the controller unit 1000a or sensor unit 1000b preferably is configured to provide the detected information from the sensor unit 1000b (such as humidity and/or temperature information) to a remotely situated component. The computing devices are depicted as a smartphone 1001a, tablet 1001b, personal computer 1001c. The computing components of one or more or both of the sensor 1000b or controller 1000a have communications circuitry that communicates to receive and/or exchange information with a computing device, such as the smartphone 1001a.

The voltage regulation component 2011 may comprise several different electronic components related to regulation and storage of power. For example, according to some embodiments, the voltage regulation component may contain a capacitor to store power (preferably a supercapacitor). The voltage regulation component may also contain circuitry to withhold power from the sensor circuitry 3009 until the aforementioned capacitor component has reached a certain voltage. It is preferable that this voltage is slightly higher than the operating voltage of the circuit to allow for a margin of error while powering the sensor circuitry 3009 in case more power is required than anticipated. The voltage regulation component 2011 also contains a voltage regulator to prevent over-voltage power to any component.

The capacitor in the voltage regulation component 2011 is especially important for receiving power from supplying devices which have different standards for wireless power. The capacitor can store energy from the initializing steps in some wireless power standards and can allow the sensor circuitry 3009 to remain compatible with power standards unknown or unrecognized by the circuitry. Even where the voltage regulation component 2011 does not contain the same wireless standard or where it contains no standard at all, and where it does not handshake with a power supplying device that is designed to provide wireless power, the voltage regulation component 2011 is configured to utilize the wireless power that the supplying device provides.

For example, a computing device 1001, with appropriate hardware, would be able to provide power to the sensor unit 1000b even if the circuitry of the sensor unit did not recognize the wireless power standard being used. Some standards require an initialization step or “handshake” step where the circuit to supply power tries to interact with the receiving circuitry. This step generates usable wireless power which may be consumed and handled by the voltage regulation component 2011 to be stored for later use. The voltage regulation component does not require compatibility with the “handshake” of the supplying device. The “handshake” itself provides usable power that the voltage regulation component may utilize even where the voltage regulation component 2011 fails the “handshake” and, even where the voltage regulation component 2011 is not able to establish an exchange of information or data between the supplying device, or verification with the power supplying device. This removes the need for continuous wireless power.

While the invention is described through the above-described exemplary embodiments, it will be understood by those of ordinary skill in the art that modifications to, and variations of, the illustrated embodiments may be made without departing from the inventive concepts disclosed herein. Embodiments of the system and devices provide a sensor electronically coupled with a first coil to receive power from a compatible second coil (controller coil), and the sensor also may display the sensor readouts on a display. Preferred embodiments are implemented with or may be configured as a humidor. Preferred embodiments are also implemented with or also may be configured as a shipping container, boat hull, building wall, or beer/wine fermentation vat. Other implementations, including monitoring of areas between or bounded by panels or walls, such as of a building structure, container, storage facility, or other space, may be carried out using the devices. According to some embodiments, optionally, the sensor unit is configured for wireless communication to communicate the sensor information for readout on a device, which may be a device other than the optional sensor display. The sensor is placed within a containment, and the controller coil (or powering computing device) outside of the containment, or in some operably spaced apart manner (i.e., within the coil radiance or signal range) from the sensor. According to some implementations and embodiments, a containment may include two compartments, one for a coil controller (or powering computing device) and the other for a sensor. For example, the coil controller and sensor could be disclosed in a containment but separated by a wall or panel. The controller unit and sensor unit are preferably separated and are in a close range, such as being on opposite sides of a panel, wall, or other structure. For example, the panel may comprise a two walled structure with a filler of air, gas, foam or other intermediate that is non-blocking or does not prevent the wireless signals from being transmitted/received. The controller unit provides wireless transmission that powers the sensor functions and allows the one or more sensors to be powered wirelessly, without the need for a battery or other power source. The sensor is powered to operate and perform the sensing functions, and also to communicate a signal that contains the information back to the controller or other device, by being powered wirelessly by the controller

For example, although some aspects of the system and method have been described with reference to diagrams and/or screen display interfaces, those skilled in the art should readily appreciate that functions, operations, decisions, etc. of all or a portion of each block, or a combination of blocks, of the flowchart or interface displays may be combined, separated into separate operations or performed in other orders. In addition, features, operations, steps, and embodiments, although described or referenced in connection with one embodiment, may be combined or implemented in conjunction with one or more other features, operations, steps, or embodiments. According to some alternate embodiments, the coil controller itself may alternatively be configured with circuitry so that it is powered wirelessly by a coil. The exemplary illustrations and depictions describe preferred embodiments, and variations of the embodiments, features, steps and operations may be implemented consistent with the invention. Moreover, while the embodiments are described in connection with various illustrative data structures, one skilled in the art will recognize that the system may be embodied using a variety of data structures. Accordingly, the invention should not be viewed as being limited to the disclosed embodiments.

What is claimed is:

1. A device for sensing conditions the device comprising:
a) at least one sensor comprising sensor that senses at least one condition of an environment, the sensor including circuitry configured to receive power wirelessly and to communicate the at least one sensed condition wirelessly to another device;
b) a controller that powers at least one sensor;
c) wherein the controller wirelessly powers the sensor, and wherein the sensor circuitry is configured to receive the power wirelessly from the controller; and
d) wherein the controller is spaced apart from the sensor a suitable distance that permits the controller to provide wireless power to the at least one sensor.
wherein the at least one sensor contains at least one capacitor for storing power.

2. The device of claim 1, wherein the at least one sensor contains at least one capacitor for storing power.

3. The device of claim 2, wherein the at least one capacitor is used to store a charge for powering the at least one sensor.

4. The device of claim 3, wherein the at least one sensor uses the at least one capacitor's stored charge only after it has reached a specified voltage.

5. The device of claim 4, wherein the specified voltage is higher than the operating voltage of the at least one sensor.

6. The device of claim 1, wherein the at least one sensor contains at least one capacitor for storing power; wherein the at least one capacitor is used to store a charge for powering the at least one sensor; and wherein the at least one sensor uses the at least one capacitor's stored charge only after it has reached a specified voltage.

7. The device of claim 1, wherein the at least one sensor includes an antenna, and wherein the controller includes an antenna.

8. The device of claim 7, wherein the controller distributes power to the at least one sensor wirelessly via a transmission from the controller antenna to the sensor antenna.

9. The device of claim 8, wherein the at least one sensor is configured to receive wireless power from the controller through a structure that divides the locations of the at least one sensor and the controller.

10. The device of claim 9, wherein the structure comprises at least one panel, and wherein the device is configured to operate in conjunction with the at least one panel, wherein the at least one panel defines an interior or first environment that the at least one sensor monitors and an exterior or second environment where the controller is located.

11. The device of claim 10, wherein the controller wirelessly powers the at least one sensor via transmission through the structure of a wireless signal.

12. The device of claim 9, wherein the structure comprises at least one wall defining an interior and an exterior, a containment space, and wherein the at least one wall defines at least in part the containment space, and wherein the at least one sensor is configured to monitor the containment space, and wherein the controller wirelessly powers the at least one sensor through the at least one wall.

13. The device of claim 11, wherein the at least one sensor receives wireless power from the controller through the panel of the structure.

14. The device of claim 12, wherein the at least one sensor is configured to operate within the containment space, and wherein the controller is configured to operate outside of the containment space.

15. The device of claim 1, wherein the controller comprises a phone.

16. The device of claim 15, wherein the phone comprises a wireless power transmitting circuit.

17. The device of claim 1, wherein the controller contains a Wi-Fi capable component.

18. The device of claim 1, wherein the controller includes controlling circuitry and wherein the controlling circuitry generates a first driving frequency.

19. The device of claim 18, wherein the controlling circuitry of the controller generates a second driving frequency.

20. The device of claim 1, wherein the sensor circuitry comprises a capacitor and a coil.

21. The device of claim 1, wherein the controlling circuitry of the controller generates a driving frequency, wherein the sensor circuitry comprises a capacitor and a coil, wherein the combination of capacitance of the sensor circuitry capacitor and coil inductance of the sensor circuitry coil has a resonant frequency that matches the driving frequency of the controller.

22. The device of claim 21, wherein the combination of capacitance of the sensor circuitry capacitor and coil inductance of the sensor circuitry coil has a resonant frequency which matches a proportion of the driving frequency of the controller.

23. The device of claim 22, wherein the driving frequency of the controller is adjustable.

24. The device of claim 1, wherein the sensor includes at least one detecting portion, and wherein the sensor circuitry is preferably hermetically sealed except for the detecting portion of the sensor.

25. The device of claim 1, wherein the controller comprises controller circuitry and wherein the controller circuitry comprises a pulse-generator or sine-wave generator which generates a driving frequency.

26. The device of claim 25, wherein the pulse or sine wave generated by the pulse-generator or sine-wave generator is sent to a capacitor-coil combination whose resonant frequency matches the generated signal.

27. The device of claim 1, wherein the at least one sensor comprises a plurality of sensors, and wherein each sensor of the plurality of sensors is configured to sense at least one condition different from that of another sensor of the plurality of sensors.
